(19) United States
(12) Patent Application Publication
(10) Pub. No.: US 2026/0063156 A1
(43) Pub. Date: Mar. 5, 2026

(54) FASTENED MEMBER

(71) Applicant: TOYOTA JIDOSHA KABUSHIKI KAISHA, Toyota-shi (JP)

(72) Inventors: Takashi USHIJIMA, Nagoya-shi (JP); Hirotaka SATO, Nagoya-shi (JP)

(21) Appl. No.: 19/263,633

(22) Filed: Jul. 9, 2025

(30) Foreign Application Priority Data
Aug. 27, 2024 (JP) 2024-145452

(51) Int. Cl. F16B 5/02

(52) U.S. Cl. CPC F16B 5/0258

(57) ABSTRACT

A fastened member to be fixed to a vehicle body-side member includes: a base portion having a reference surface configured to receive a bearing surface of a screw member, the base portion including an insertion hole portion in which the screw member is to be inserted; and a deformation portion provided on the reference surface. The deformation portion and the base portion are configured to be plastically deformed and elastically deformed while being sandwiched between the vehicle body-side member and the bearing surface when the base portion is fastened to the vehicle body-side member by the screw member.

### CROSS-REFERENCE TO RELATED APPLICATION

This application claims priority to Japanese Patent Application No. 2024-145452 filed on Aug. 27, 2024. The disclosure of the above-identified application, including the specification, drawings, and claims, is incorporated by reference herein in its entirety.

### BACKGROUND

### 1. Technical Field

The present disclosure relates to a fastened member to be fastened to a vehicle body-side member by a screw member.

### 2. Description of Related Art

Japanese Unexamined Patent Application Publication No. 2010-253697 (JP 2010-253697 A) discloses that a fiber reinforced composite material formed of a thermosetting resin and carbon fibers in layers is fastened to a metal material by a bolt. The fiber reinforced composite material includes a fastening through-hole for use in inserting the bolt, and an iron coating layer on the inner periphery of the through-hole. The iron coating layer is formed by causing powder to adhere to the through-hole.

### SUMMARY

In the fiber reinforced composite material disclosed in JP 2010-253697 A, iron is caused to adhere to the fastening through-hole, and hence a material different from a base material is prepared, and processing of causing the material to adhere is further performed, resulting in increase in cost.

The present disclosure provides a technology of reducing creep deformation while reducing cost in a fastened member to be fastened by a screw member.

One aspect of the present disclosure relates to a fastened member configured to be fixed to a vehicle body-side member, the fastened member including: a base portion having a reference surface configured to receive a bearing surface of a screw member, the base portion including an insertion hole portion in which the screw member is to be inserted; and a deformation portion provided on the reference surface. The deformation portion and the base portion are configured to be plastically deformed and elastically deformed while being sandwiched between the vehicle body-side member and the bearing surface when the base portion is fastened to the vehicle body-side member by the screw member.

The deformation portion may be a projecting portion projecting from the reference surface.

The projecting portion may include a plurality of projecting portions. The projecting portions may be provided to be spaced apart from each other in a circumferential direction of the reference surface.

The projecting portions may include the projecting portion provided such that a part of the projecting portion protrudes to an outer side in a radial direction of the bearing surface in a state in which the reference surface receives the bearing surface.

The projecting portions may include the projecting portion in which a width in a radial direction of the reference surface is longer than a width in the circumferential direction.

The projecting portions may include the projecting portion having a sector shape in which a width in the circumferential direction is increased outwardly in the radial direction of the reference surface.

The projecting portions may be positioned to be separated from an edge of the insertion hole portion.

The fastened member may further include a case configured to support an electronic component, and an extending portion extending from the case to be coupled to the base portion. The reference surface may have a first region and a second region that are obtained by dividing the reference surface into half, and the first region may be positioned closer to the extending portion than the second region. The number of the projecting portions disposed in the first region may be smaller than the number of the projecting portions disposed in the second region.

With the present disclosure, it is possible to provide the technology of reducing the creep deformation while reducing the cost in the fastened member to be fastened by the screw member.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view illustrating a fastened member fixed to a vehicle body-side member by a screw member of an embodiment;

FIG. 2A is a top view of the fastened member;

FIG. 2B is a sectional view taken along the line IIB-IIB of a base portion illustrated in FIG. 2A;

FIG. 3A is an explanatory view illustrating fastening of the base portion by the screw member;

FIG. 3B is an explanatory view illustrating fastening of the base portion by the screw member;

FIG. 4A is a sectional view of the fastened member in a fastening completed state;

FIG. 4B is a sectional view of the fastened member in the fastening completed state; and

FIG. 5 is a plan view of a fastened member of a modification example.

### DETAILED DESCRIPTION OF EMBODIMENTS

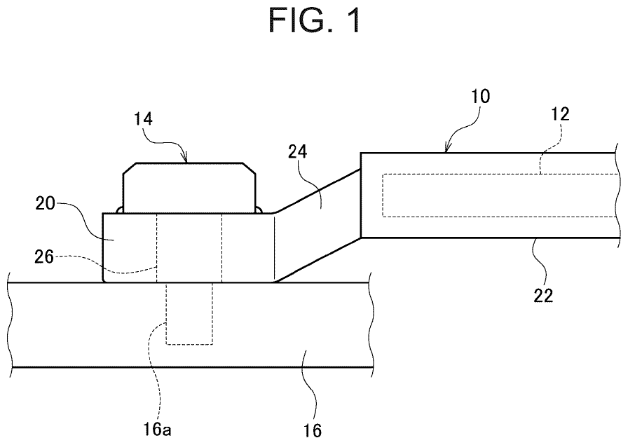

FIG. 1 is a view illustrating a fastened member 10 fixed to a vehicle body-side member 16 by a screw member 14 of an embodiment. The fastened member 10 includes a base portion 20, a case 22, and an extending portion 24, and is integrally formed with the same resin material.

The case 22 accommodates and holds an electronic component 12. The electronic component 12 may be an electronic board such as an in-vehicle electronic control unit (ECU). The electronic board may be disposed in the vertical direction, or may be disposed in the horizontal direction. That is, the fastened member 10 functions as a component holding member that holds the electronic component 12.

The extending portion 24 is formed in a columnar shape, and extends from the case 22. The base portion 20 is fixed to the vehicle body-side member 16 by the screw member 14. When being fastened to the vehicle body-side member 16, the base portion 20 is brought to a state of being sandwiched between the screw member 14 and the vehicle body-side member 16, and is pressed to the vehicle body-side member 16 by an axial force of the screw member 14. The base portion 20 includes an insertion hole portion 26 in which the screw member 14 can be inserted. A plurality of base portions 20 and a plurality of extending portions 24 are provided to the case 22.

The vehicle body-side member 16 is, for example, a vehicle body panel, a vehicle body frame, or a metal bracket fixed to the vehicle body frame, and is a member configuring a vehicle body. The vehicle body-side member 16 includes a screw hole portion 16a configuring a female screw. The screw member 14 fastens the base portion 20 to the vehicle body-side member 16. The screw member 14 is, for example, a bolt.

The case 22 is positioned to be separated from the surface of the vehicle body-side member 16. For the extending portion 24, a shape, a length, and an angle with respect to the case 22 can be set in accordance with a mounting position of the electronic component 12, and the extending portion 24 is not limited to the aspect illustrated in FIG. 1. In any case, the extending portion 24 extends toward the vehicle body-side member 16 serving as a mounting target. The base portion 20 is coupled to the extending portion 24.

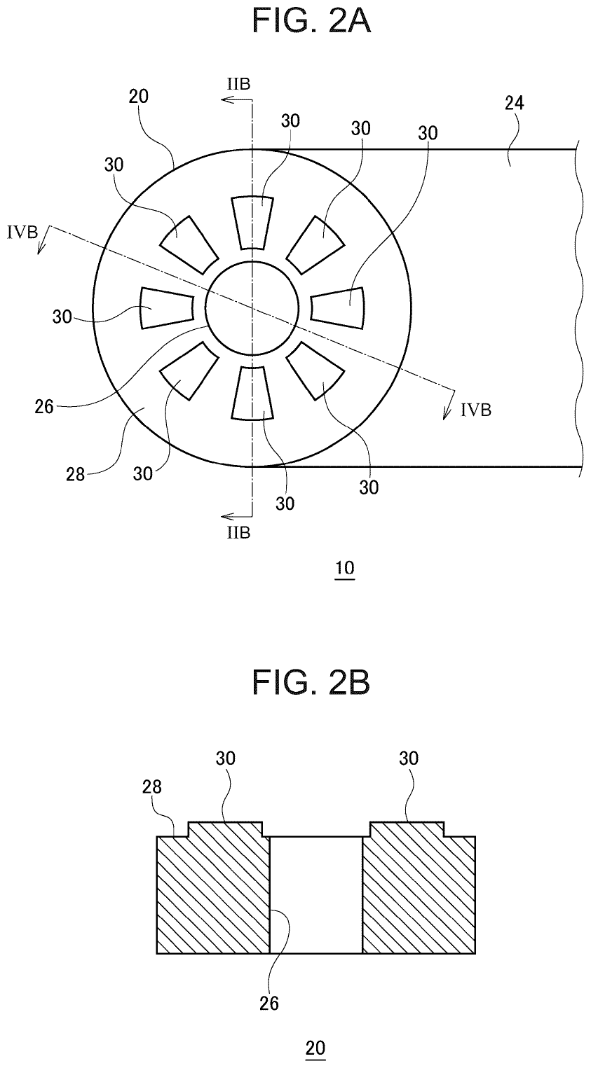

FIG. 2A is a top view illustrating a part of the fastened member 10, and FIG. 2B is a sectional view taken along the line IIB-IIB of the base portion 20 illustrated in FIG. 2A. The base portion 20 includes an insertion hole portion 26, a reference surface 28, and a projecting portion 30.

The insertion hole portion 26 is formed at the middle of the base portion 20 to pass through the base portion 20, and a screw portion of the screw member 14 can be inserted to the insertion hole portion 26. A center axial direction of the insertion hole portion 26 is simply referred to as an axial direction. It is to be noted that the center axial direction of the insertion hole portion 26 and the axial direction of the screw member 14 in the state of being mounted to the vehicle body-side member 16 are substantially the same. Further, a circumferential direction of the reference surface 28 refers to a direction that is orthogonal to the axial direction and rotates about the axis. Further, a radial direction of the reference surface 28 refers to a direction that is orthogonal to the axial direction and extends in a radiation direction.

The reference surface 28 is a surface of the base portion 20, and is formed flat. The projecting portion 30 is formed to project from the reference surface 28. The projecting portion 30 includes a plurality of projecting portions 30. The projecting portions 30 are formed to be spaced apart from each other in the circumferential direction of the reference surface 28. With the projecting portions 30 being provided to be separated from each other, the projecting portion 30 can be easily crushed as compared to the case in which the projecting portion 30 is annularly formed.

The projecting portion 30 is formed such that a width in the radial direction is longer than a width in the circumferential direction. Further, the projecting portions 30 may include the projecting portion 30 formed such that the width in the radial direction is longer than the width in the circumferential direction. This projecting portion 30 is formed in an elongated shape along the radial direction. In this manner, the projecting portion 30 is formed so as to extend radially, and a stress is generated on both of the radially inner side and the radially outer side when the base portion 20 is fastened to the vehicle body-side member 16. Thus, an unbalanced stress can be reduced.

The projecting portion 30 is formed in a sector shape in which the width in the circumferential direction is increased outwardly in the radial direction of the reference surface 28. The projecting portions 30 may include the projecting portion 30 formed in the sector shape in which the width in the circumferential direction is increased outwardly in the radial direction of the reference surface 28. The projecting portion 30 has the width in the circumferential direction that differs between the radially inner side and the radially outer side of the reference surface 28, and hence the stress to be generated when the base portion 20 is fastened to the vehicle body-side member 16 can be set to be reduced from the radially inner side toward the radially outer side. In this manner, the creep deformation can be reduced toward the radially outer side, the fastening force on the radially outer side on which the contact surface is increased in area can be maintained, and the rattling can be reduced over time.

The projecting portions 30 are positioned to be separated from an edge of the insertion hole portion 26. In this manner, it is possible to reduce, when the base portion 20 is fastened to the vehicle body-side member 16, crushing of some of the projecting portions 30 radially inwardly to cause an action of tilting the screw member 14.

The projecting portions 30 are disposed at positions closer to an inner peripheral edge than an outer peripheral edge of the base portion 20. The projecting portions 30 are formed flat. The projecting portions 30 may be formed with curved surfaces, or may be formed in, for example, a hemispherical shape or a semi-spheroidal shape. The projecting portions 30 may be spaced apart not only in the circumferential direction but also in the radial direction.

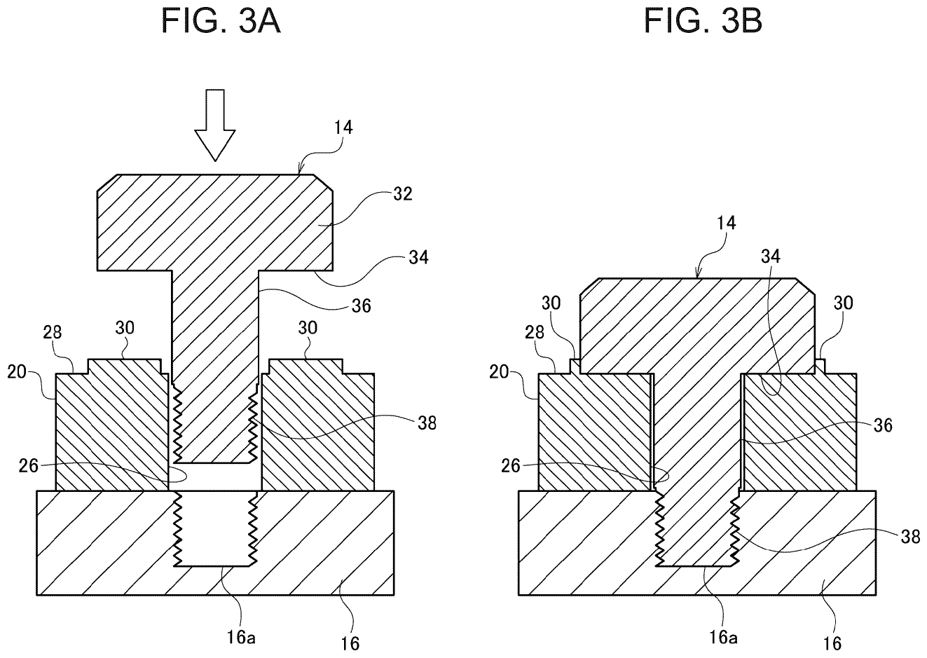

FIG. 3A and FIG. 3B are explanatory views illustrating fastening of the base portion 20 by the screw member 14. FIG. 3A illustrates the base portion 20 in a state before the fastening, and FIG. 3B illustrates the base portion 20 in a fastening completed state. FIG. 3A and FIG. 3B are sectional views at a position taken along the line IIB-IIB of the base portion 20 illustrated in FIG. 2A.

The screw member 14 includes a head portion 32, a bearing surface 34, a cylindrical portion 36, and a screw portion 38. The bearing surface 34 is positioned on the rear surface of the head portion 32. The cylindrical portion 36 is positioned on the head portion 32 side from the screw portion 38, and extends downward from the rear surface of the head portion 32. The screw portion 38 configures a male screw. The head portion 32 is rotated by a tool such that the screw portion 38 advances and retreats with respect to the screw hole portion 16a.

As illustrated in FIG. 3A, in a state in which the base portion 20 is placed on the vehicle body-side member 16, the insertion hole portion 26 is positionally aligned with the screw hole portion 16a of the vehicle body-side member 16, and the screw member 14 is to be inserted to the insertion hole portion 26. The insertion hole portion 26 has a diameter larger than diameters of the cylindrical portion 36 and the screw portion 38.

As illustrated in FIG. 3B, the screw portion 38 is threadedly engaged with the screw hole portion 16a, and the bearing surface 34 presses the projecting portion 30. The projecting portion 30 is deformed as being crushed, and the reference surface 28 receives the bearing surface 34. The screw member 14 is screwed until the screw member 14 reaches the reference surface 28 while deforming the projecting portion 30 and the surroundings thereof.

The projecting portion 30 configures a deformation portion that is pressed and deformed by the bearing surface 34 when the base portion 20 is fastened by the screw member 14. The projecting portion 30 that is the deformation portion is at least plastically deformed, and may partially be elastically deformed.

As illustrated in FIG. 3B, the projecting portion 30 protruding from the head portion 32 is left. The projecting portions 30 includes the projecting portion 30 formed such that a part of the projecting portion 30 protrudes to the outer side in the radial direction of the bearing surface 34. That is, the projecting portion 30 extends to the outer side in the radial direction from the bearing surface 34, and is formed at a position at which a part of the projecting portion 30 protrudes to the outer side in the radial direction of the bearing surface 34. In this manner, an operator can visually check the crushing level of the projecting portion 30 to check the fastening degree of the screw member 14.

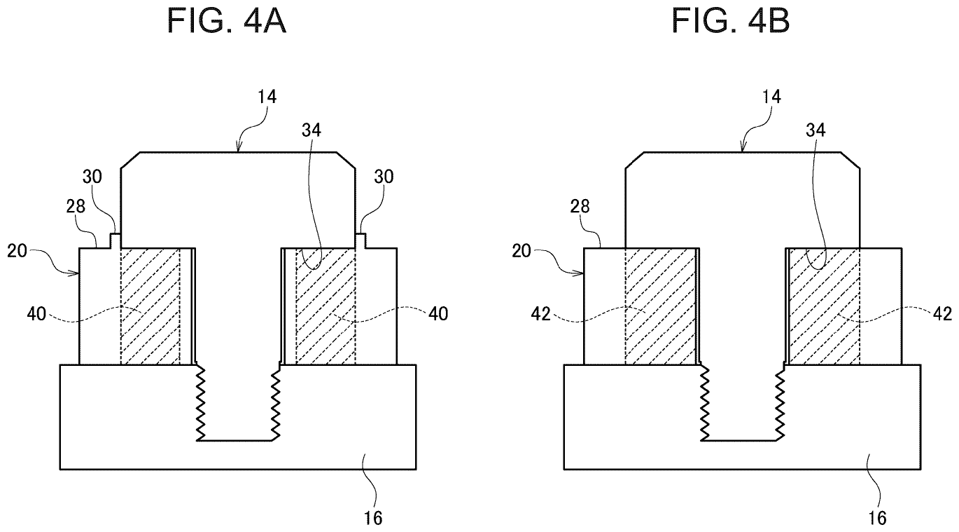

FIG. 4A and FIG. 4B are sectional views of the fastened member 10 in the fastening completed state. FIG. 4A illustrates a section at a position taken along the line IIB-IIB of the base portion 20 illustrated in FIG. 2A, and FIG. 4B illustrates a section at a position taken along the line IVB-IVB of the base portion 20 illustrated in FIG. 2A. That is, FIG. 4A illustrates a section of a part provided with the projecting portion 30, and FIG. 4B illustrates a section of a part not provided with the projecting portion 30.

As illustrated in FIG. 4A, the projecting portion 30 and a part of the base portion 20 positioned on the rear side of the projecting portion 30 form a first deformation region 40 that is integrally deformed by being pressed by the bearing surface 34. The first deformation region 40 is a part to be pressed by the bearing surface 34. The first deformation region 40 includes the projecting portion 30, and is a region of the base portion 20 overlapping the projecting portion 30 in the axial direction. As illustrated in FIG. 4B, the base portion 20 not provided with the projecting portion 30 forms a second deformation region 42 when the reference surface 28 is pressed by the bearing surface 34. The second deformation region 42 is a region of the base portion 20 overlapping the bearing surface 34 but not overlapping the projecting portion 30.

The first deformation region 40 is longer than the second deformation region 42 in the axial direction by the height of the projecting portion 30, and hence the stress is increased. Accordingly, the first deformation region 40 is plastically deformed and also elastically deformed. In the first deformation region 40, the projecting portion 30 is not only plastically deformed, and the entire first deformation region 40 is compressed. It may be difficult to distinguish the boundary between the plastic deformation and the elastic deformation, but the first deformation region 40 is plastically deformed at a volume ratio larger than that of the second deformation region 42. The second deformation region 42 is elastically deformed, and may be plastically deformed depending on the axial force of the screw member 14.

The projecting portions 30 are spaced apart in the circumferential direction, and hence the first deformation region 40 having a large stress and the second deformation region 42 having a small stress are positioned separately in the circumferential direction. Accordingly, the stress applied to the first deformation region 40 can be relieved to the second deformation region 42, and the occurrence of creep in the first deformation region 40 can be reduced.

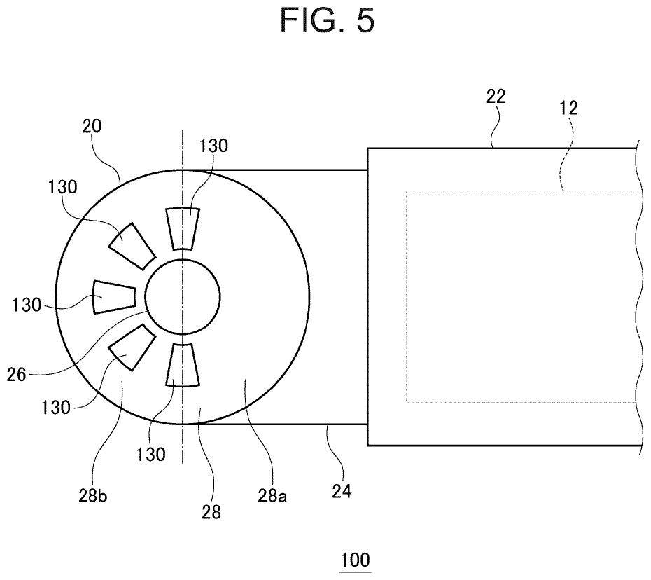

FIG. 5 is a plan view of a fastened member 100 of a modification example. The fastened member 100 of the modification example is different from the fastened member 10 illustrated in FIG. 2A in arrangement of a plurality of projecting portions 130.

The reference surface 28 includes a first region 28a and a second region 28b. The first region 28a and the second region 28b each have an area obtained by dividing the area of the reference surface 28 into half by a straight line passing through the center axis. The first region 28a is positioned closer to the extending portion 24 than the second region 28b. The first region 28a is positioned on the extending portion 24 side from the second region 28b, and is continuous with the extending portion 24 in top view. The second region 28b may be disposed so as not to be continuous with the extending portion 24 in top view. The first region 28a may be positioned on a side closer to the case 22 than the second region 28b.

The first region 28a closer to the extending portion 24 receives a load via the extending portion 24 from the case 22. Accordingly, the first deformation region 40 formed in the first region 28a may receive an excessively large stress. In view of the above, the projecting portions 130 are disposed more on the second region 28b than on the first region 28a. In this manner, the creep deformation in the first deformation region 40 positioned on the extending portion 24 side can be reduced.

It is to be noted that FIG. 5 illustrates as aspect in which the projecting portions 130 are disposed on the reference surface 28 halfway around, and are disposed to substantially avoid the first region 28a, but the present disclosure is not limited to this aspect. The projecting portions 130 may be disposed in accordance with the load to be applied from the extending portion 24, for example, may be disposed not halfway around but in a region excluding a region for 90 degrees or 120 degrees in rotation angle.

Hereinabove, the present disclosure has been described based on the embodiment. The present disclosure is not limited to the above-mentioned embodiment, and various modifications such as design changes can be made thereto based on the knowledge of the person skilled in the art.

For example, the fastened member 10 may be integrally configured of the base portion 20 and the extending portion 24, and may be coupled to a different member such as the case 22.

What is claimed is:

1. A fastened member configured to be fixed to a vehicle body-side member, the fastened member comprising:
a base portion having a reference surface configured to receive a bearing surface of a screw member, the base portion including an insertion hole portion in which the screw member is to be inserted; and
a deformation portion provided on the reference surface,
wherein the deformation portion and the base portion are configured to be plastically deformed and elastically deformed while being sandwiched between the vehicle body-side member and the bearing surface when the base portion is fastened to the vehicle body-side member by the screw member.

2. The fastened member according to claim 1, wherein the deformation portion is a projecting portion projecting from the reference surface.

3. The fastened member according to claim 2, wherein the projecting portion includes a plurality of projecting portions, the projecting portions being provided to be spaced apart from each other in a circumferential direction of the reference surface.

4. The fastened member according to claim 3, wherein the projecting portions include the projecting portion provided such that a part of the projecting portion protrudes to an outer side in a radial direction of the bearing surface in a state in which the reference surface receives the bearing surface.

5. The fastened member according to claim 3, wherein the projecting portions include the projecting portion in which a width in a radial direction of the reference surface is longer than a width in the circumferential direction.

6. The fastened member according to claim 3, wherein the projecting portions include the projecting portion having a sector shape in which a width in the circumferential direction is increased outwardly in a radial direction of the reference surface.

7. The fastened member according to claim 3, wherein the projecting portions are positioned to be separated from an edge of the insertion hole portion.

8. The fastened member according to claim 3, further comprising:
a case configured to support an electronic component; and
an extending portion extending from the case to be coupled to the base portion, wherein:
the reference surface has a first region and a second region that are obtained by dividing the reference surface into half;
the first region is positioned closer to the extending portion than the second region; and
the number of the projecting portions disposed in the first region is smaller than the number of the projecting portions disposed in the second region.
